(19) United States
(12) Patent Application Publication
(10) Pub. No.: US 2015/0359039 A1
(43) Pub. Date: Dec. 10, 2015

(54) SYSTEM FOR FACILITATING SEARCHING IN THE INTERNET OF THINGS

(71) Applicants: Usman Abdul Haque, London (GB); Samuel Naumkamba David Heney Mulube, Penicuik Midlothian (GB); Pedro Nuno Calvalho Monteiro Correia, London (PT)

(72) Inventors: Usman Abdul Haque, London (GB); Samuel Naumkamba David Heney Mulube, Penicuik Midlothian (GB); Pedro Nuno Calvalho Monteiro Correia, London (PT)

(73) Assignee: Umbrellium LTD., London (GB)

(21) Appl. No.: 14/298,322

(22) Filed: Jun. 6, 2014

(51) Int. Cl. H04W 84/18

(52) U.S. Cl. CPC H04W 84/18

(57) ABSTRACT

A system is described for creating a score for measurement devices 14, 16, 18 in order to facilitate a search for measurement devices in the internet of things. The system includes a server 12 with an indexing subsystem 30 that can retrieve measurement data from the plurality of measurement devices. The server 12 also determines a second set of data based on user interaction with the plurality of physical devices in the network. A ranking subsystem 38 in the server 12 can then determine a score for each of the plurality of devices based on the first set of data and the second set of data. The score is reflective of the quality of data and the credibility and popularity of the measurement devices among users. A presentation subsystem 36 outputs a geographic map in response to a user's search including a plurality of markers associated with the measurement devices. The opacity of the markers on the map is dependent on the score determined by the ranking subsystem 38.

This invention relates to a system and method for facilitating internet searches for measurement devices in the internet of things. This is achieved by providing a presentation system for search results, and a system and method for creating scores for measurement devices.

The internet of things comprises objects that are accessible over a network. Typically these objects are measurement devices that have some capability for sensing their environment and providing measurement data. These devices are already an important component of connected technology, and their importance is expected to increase in the coming years, together with their number.

Web pages are typically indexed and ranked by search engine databases, which evaluate links between web pages in order to estimate their relative relevance. In the internet of things there are no links between individual measurement devices. Therefore, existing techniques for indexing and ranking web pages cannot be transferred easily. At present there is no readily available method for assessing the relevance and quality of measurement devices for an internet user. The present inventors are not aware of any proven techniques for searching for measurement devices in the internet of things.

An object of the invention is to provide a system for determining a score for measurement devices in the internet of things that properly represents the relevance of the devices to a user. More specifically, the invention is intended to create a score that is reflective of the quality of data from the device as well as the popularity or credibility of the device among other users. Another object of the invention is to provide a system for improving the presentation of search results in the internet of things.

According to the present invention there is provided a system configured to create a score for a plurality of measurement devices in a network, wherein the system comprises: an indexing subsystem configured to retrieve a first set of data from the plurality of measurement devices in the network; a user interaction subsystem configured to determine a second set of data regarding user interaction with the plurality of physical devices in the network; a scoring module configured to determine a score for each of the plurality of devices based on the first set of data and the second set of data; and a presentation subsystem configured to output an indication of the determined score for at least some of the plurality of measurement devices.

In this way a system is provided for creating a score for devices in the internet of things. Measurement devices in the network can receive a score that is reflective of the quality of data from the device as well as their popularity or credibility with users. It has been found that this combination can create a meaningful score which is indicative of the relevance of the device in the internet of things. This can provide a useful tool to allow effective searching for devices.

Preferably the system includes a data storage unit configured to store properties for the plurality of measurement devices, wherein the presentation subsystem is configured to output at least one property for each measurement device together with the indication of the determined score. The stored properties may be static in the sense that they are not intended to vary.

Examples of static properties include the location of the measurement device, an internet address for the measurement device, a title for the measurement device, a description for the measurement device, and an indication of the type of measurement data produced by the measurement device. In this way several properties for each measurement device can be output together with the determined score. This can permit a user to decide whether to select the measurement device in order to find out more information. In one embodiment the geographic location of the measurement device is output using a selectable marker on a map, and further properties may be revealed when the user selects the marker.

Preferably the indexing subsystem is configured to retrieve the first set of data by accessing the internet address stored in the data storage unit for the relevant measurement device. In this way the indexing subsystem can poll the devices to access current measurement data. The quality of these data can be used to create a score for the devices.

The scoring module may be configured to determine a score for a measurement device based on the availability of measurement data and/or the frequency with which the measurement data are updated. Preferably a higher score is provided for measurement devices where measurement data are available and updated frequently. These measurement devices may be more likely to provide accurate real-time data. By providing a higher score an indication of these devices can be displayed with more prominence by the presentation subsystem.

The scoring module may also be configured to determine a score for a measurement device based on the congruency of its measurement data with other devices in the network. Thus, the measurement data for one device can be compared with measurement data from comparable devices in a local area. Preferably a higher score is provided for measurement devices that provide measurement data that is similar or consistent with that of other measurement devices in a local area. In one example the measurement device may be a weather station that provides measurement data relating to temperature. A higher score may be provided for the weather station if its temperature data is similar to the temperature reported by other weather stations, since this means that its measurements are likely to be accurate (and therefore of greater interest to users searching within the internet of things). Conversely, if the temperature data is inconsistent with other weather stations in the local area then a lower score may be provided.

The scoring module may be configured to determine a score for a measurement device based on the completeness of its measurement data. A higher score may be determined for measurement devices that are providing a complete set of data, since these devices may be more reliable. In the example of a weather station, the device may be configured to supply data relating to temperature, pressure, humidity and wind speed/direction. If the weather station is only able to supply a subset of these measurements then a lower score may be calculated since the device may be of reduced interest to users who would typically want to access a fully functional weather station. An incomplete set of data may also be indicative of a fault which could warrant a lower score.

Preferably the second set of data includes information indicative of the popularity and/or credibility of measurement devices among users. In one embodiment the second set of data may include one or more of the following: user endorsements of devices, user denouncements of devices, user comments on devices, information regarding the access of data from measurement devices, and user ownership of devices.

In one example a higher score may be provided for a device whose data have been accessed and used by a large number of users since this may be indicative of the device's popularity. A higher score is preferably provided for popular devices since these are more likely to be of interest to other users who are searching in the internet of things.

In another example a higher score may be provided for a device which has had a large number of user endorsements since this may be indicative of a high quality of data and/or popularity of the device. These factors would warrant a high score to increase the prominence of the device in a search.

The score may be determined differently according to popularity and/or credibility in different user categories. Trusted users may be considered more influential and their interaction with devices may be treated with greater importance when determining a score for the measurement devices. Therefore, if influential users consider a device to be popular and/or credible then this may generate a higher score than an equivalent opinion by untrusted users.

Preferably a plurality of categories are provided, which may include anonymous, authenticated, verified and expert. Greater scores may be provided in the latter categories for equivalent user interaction.

Preferably the system comprises a word search subsystem configured to receive a search string from a user and return results for matches in the title and/or description of measurement devices. In this way a user can search for devices in the internet of things and be presented with the most highly scoring results.

In one embodiment a score may be determined based on the closeness of match between the search string and the title and/or description. This score may be combined with the score from the scoring module to determine an overall score for each measurement device in the search. These results may be output so that the searching user can review the most relevant measurement devices. In another embodiment the word search subsystem may return binary results indicating match or no-match.

The presentation subsystem may be configured to output a geographic map including a plurality of markers associated with the positions of matching results. At least one aspect of the appearance of each marker may be dependent on the score determined by the scoring module. It has been found that this is an effective technique for presenting results. A user can explore the visual map in order to find devices based on their location. In addition, the system can guide users effectively to the devices that are of most interest using the unique scoring system. It has been found that a geographic map is a particularly useful way to represent information relating to measurement devices, since users are typically interested in measurement device data in the context of a geographic location. This enables users to decide whether they are more interested in low resolution and/or low quality data at a location that is near to them rather than high resolution and/or high quality data which is non-proximal to their location.

The prominence and/or opacity of each marker may be dependent on the score. In this way highly scoring matches can be indicated on the map using highly opaque markers. This may be used to indicate the devices that are likely to be of most interest.

Another aspect of the appearance of each marker may be dependent on the type of the measurement device. In one example, different categories of measurement device may be indicated using coloured markers.

In an alternative arrangement the presentation subsystem may be arranged to output a list of results, wherein the order to the results is based on the scores for the respective devices. In some configurations it may be preferable to output results in this way; this may depend on the availability of space on the display screen.

The presentation subsystem may be configured to determine a position for the user from whom the search string is received, and the positions of the plurality of markers may be within a predetermined distance of the determined position for the user. In this way the geographic map can include matching results within a specific region, centred on the user. This can focus the user's attention on local matching results, which are likely to be of greatest interest. In a preferred arrangement the geographic map is centred on the user's position.

The position of the user who submits the search string may be determined using any of a variety of techniques. In one arrangement their position may be based on the IP address of the computer used to submit the search string. In an alternative their position may be based on a GPS position calculated by a mobile device that is used to submit the search string.

The scale of the geographic map may be determined based on a geographical term in the search string. In one example, if the user refers to a specific geographic location, such as “New York City”, in the search string then this may be used when scaling the map. In this example the geographic map could be scaled such that the whole of the city of New York is displayed. A larger scale may be provided if the user refers to a smaller geographic area such as “Manhattan” or “SoHo”.

Preferably the system includes a display screen configured to display the indication of the determined score for at least some of the plurality of measurement devices. The display screen may be in a location associated with a user who submits a search request to the internet of things.

According to the present invention there is provided a system configured to return the results of a search query for measurement devices in a network, wherein the system comprises: a word search subsystem configured to receive a search string from a user and search for matching results in the titles and/or descriptions of measurement devices, wherein the word search subsystem determines a score for each measurement device which is indicative of the closeness of match; and a presentation subsystem configured to output a geographic map including a plurality of markers associated with the positions of matching results, wherein at least one aspect of the appearance of each marker is dependent on the score.

According to yet another aspect of the invention there is provided a method of creating a score for a plurality of measurement devices in a network, the method comprising the steps of: retrieving a first set of data from the plurality of measurement devices in the network; determining a second set of data regarding user interaction with the plurality of physical devices in the network; determining a score for each of the plurality of devices based on the first set of data and the second set of data; outputting an indication of the determined score for at least some of the plurality of measurement devices.

According to yet another aspect of the invention there is provided a non-transitory computer readable storage medium having a computer program stored thereon, the computer program comprising processor readable instructions that, when executed, direct a device to perform actions comprising: retrieving a first set of data from the plurality of measurement devices in the network; determining a second set of data regarding user interaction with the plurality of physical devices in the network; determining a score for each of the plurality of devices based on the first set of data and the second set of data; and outputting an indication of the determined score for at least some of the plurality of measurement devices.

According to another aspect of the invention there is provided a method of returning the results of a search query for measurement devices in a network, wherein the method comprises the steps of: receiving a search string from a user; searching for matching results in the titles and/or descriptions of measurement devices; determining a score for each measurement device which is indicative of the closeness of match; outputting a geographic map including a plurality of markers associated with the positions of matching results, wherein at least one aspect of the appearance of each marker is dependent on the score.

According to yet another aspect of the invention there is provided a non-transitory computer readable storage medium having a computer program stored thereon, the computer program comprising processor readable instructions that, when executed, direct a device to perform actions comprising: receiving a search string from a user; searching for matching results in the titles and/or descriptions of measurement devices; determining a score for each measurement device which is indicative of the closeness of match; outputting a geographic map including a plurality of markers associated with the positions of matching results, wherein at least one aspect of the appearance of each marker is dependent on the score.

Method features may be provided as corresponding apparatus features and vice-versa.

Embodiments of the present invention will now be described, by way of example only, with reference to the accompanying drawings in which:

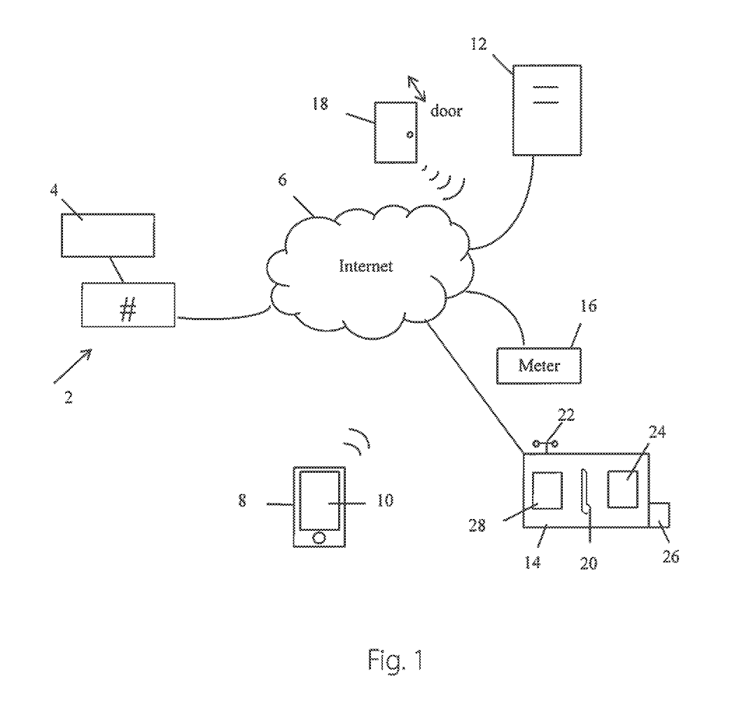

FIG. 1 is a schematic diagram showing computational hardware in an embodiment of the invention;

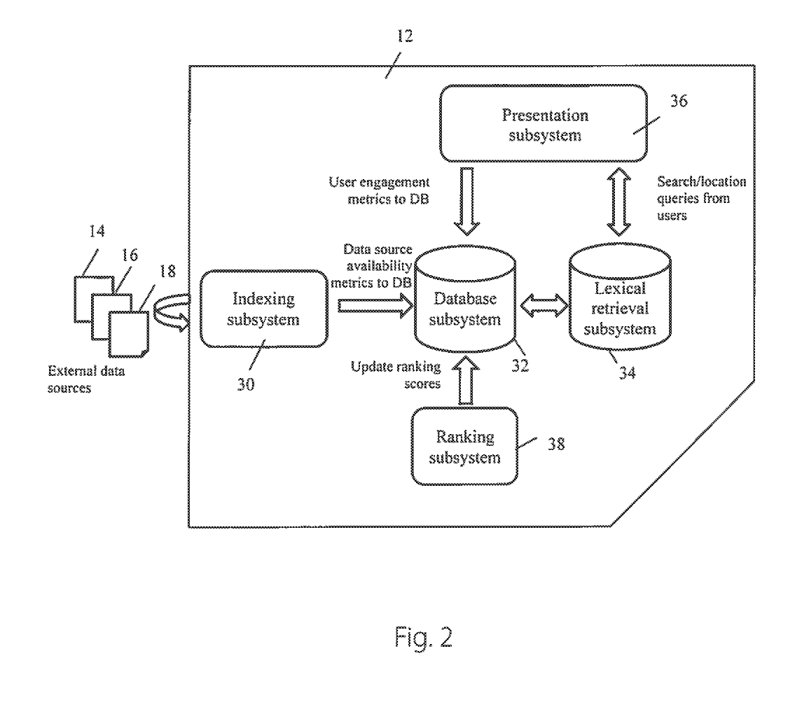

FIG. 2 is a schematic diagram showing the various subsystems that may be deployed in a server in an embodiment of the invention;

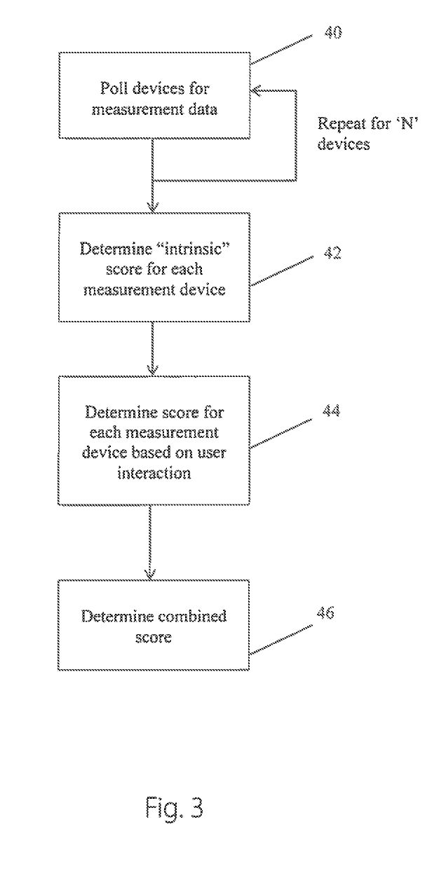

FIG. 3 is a flow diagram showing the steps that are undertaken to create a score for each measurement device in an embodiment of the invention;

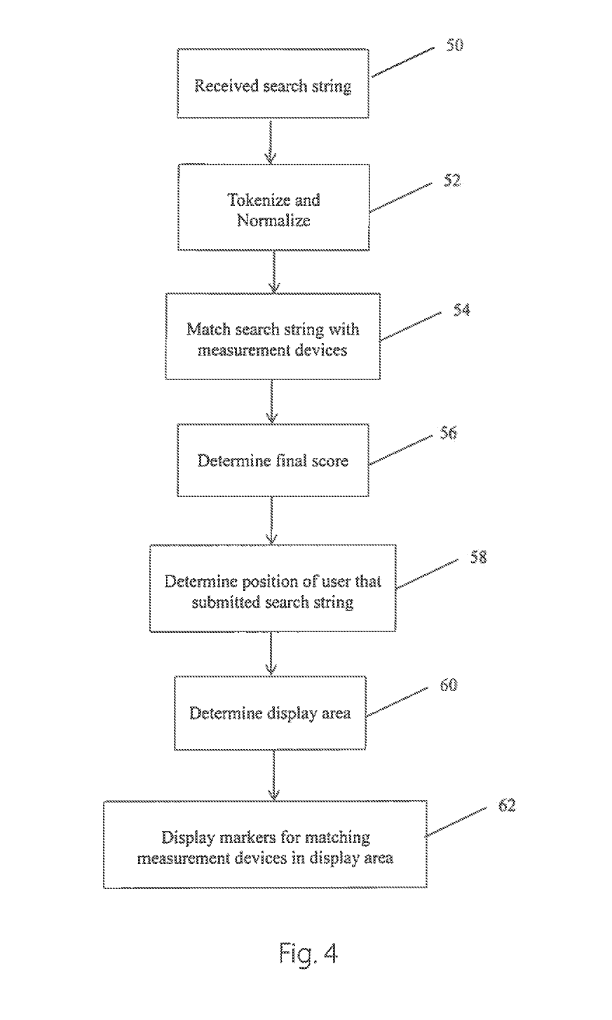

FIG. 4 is a flow diagram showing the steps that are undertaken in order to match a user's search string with measurement devices and output a geographic map in an embodiment of the invention;

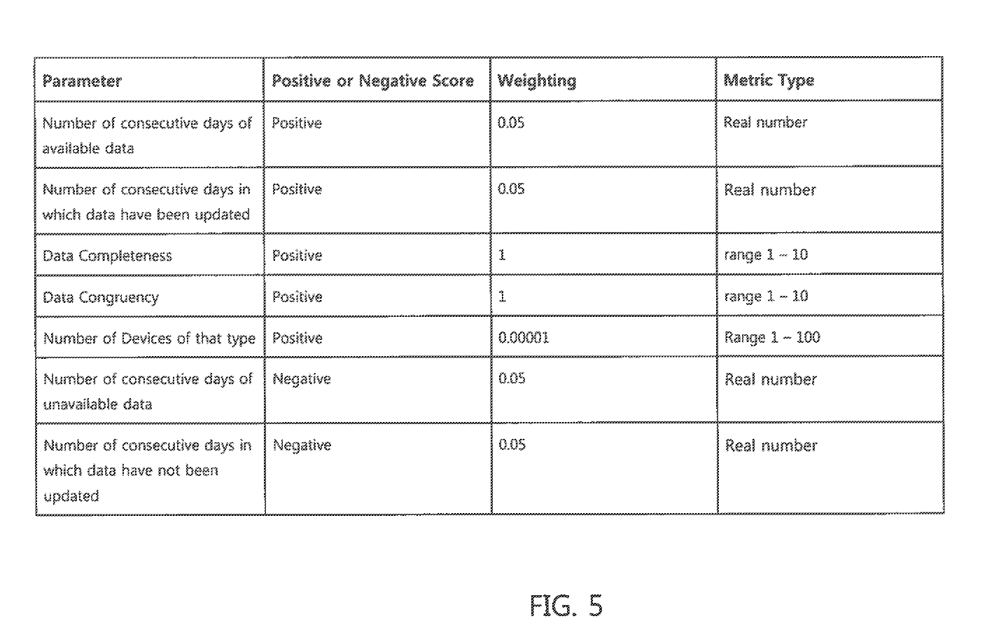

FIG. 5 is a table showing the score provided for different parameters, when determining an intrinsic score for a measurement device, in an embodiment of the invention; and

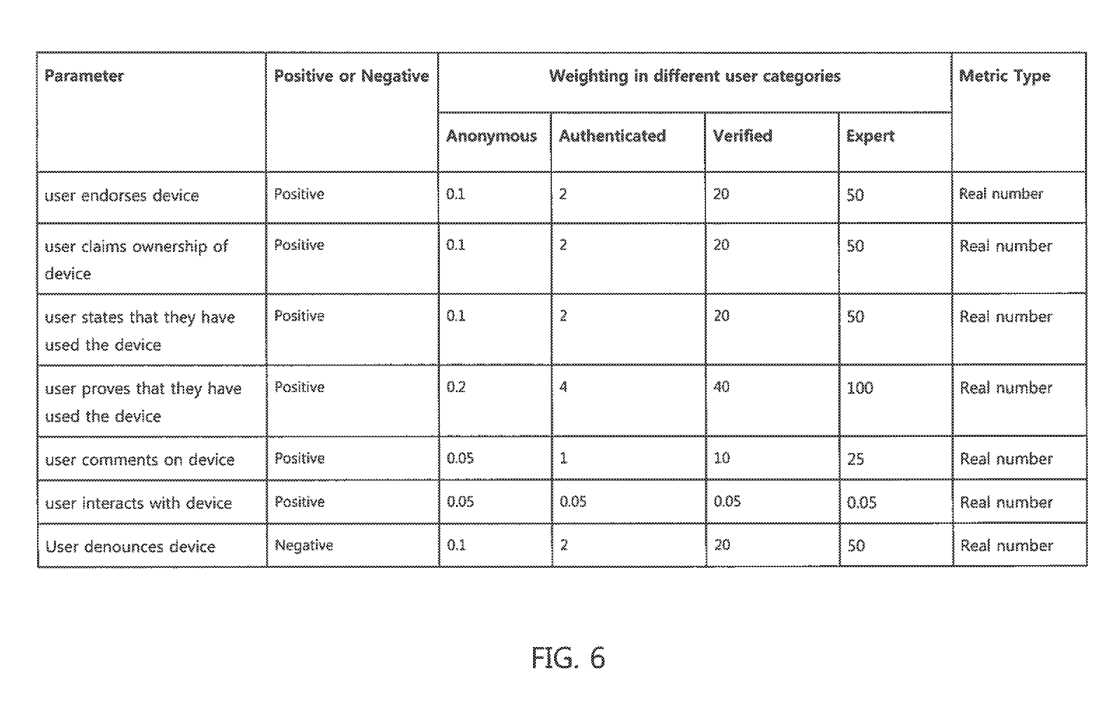

FIG. 6 is a table showing the score provided for different parameters, when determining a score based on user interaction with measurement devices, in an embodiment of the invention.

FIG. 1 shows a user computer 2, including a display screen 4 which is connected to the internet 6. A smartphone 8 is shown as an alternative user device, also including a display screen 10 and connected to the internet 6 wirelessly. A number of measurement devices 14, 16, 18 are also connected to the internet 6. In this example the measurement devices include a weather station 14, a smart electricity meter 16 and a door sensor 18 in a home security system. The weather station includes a number of sensors, including a thermometer 20, an anemometer 22, a pressure gauge 24, a rain gauge 26 and a humidity sensor 28. The smart electricity meter 16 is configured to measure consumption of electricity, and/or other supplied utilities, in a domestic or commercial environment. The door sensor 18 is configured to measure whether a particular door in a monitored environment is open or closed. Each of the measurement devices 14, 16, 18 is associated with a particular geographic position and their data are accessible over the internet 6 by accessing respective URLs. Only three measurement devices 14, 16, 18 are shown in this example, but in reality a very large number of connected measurement devices may be provided, dedicated to a large number of different tasks.

A server 12 is also connected to the internet 6 and can be used for ranking and indexing the measurement devices. More detail of the server 12 is shown in FIG. 2, which is a schematic diagram showing an indexing subsystem 30, a database subsystem 32, a lexical retrieval subsystem 34, a presentation subsystem 36 and a ranking subsystem 38. In this example the various subsystems are co-located in the same server 12, but in other configurations the subsystems could be distributed among a number of servers in different locations.

The server 12 is configured to store information in the database subsystem 32 for each measurement device in the network. In particular, the database subsystem 32 stores a geographic location for each device (for example as a latitude and longitude), the remote data source URL from which data for the device can be retrieved, a title and description for the device, metadata tags, a snapshot of the data channels available from the device, a metric type for the device, and a category for the measurement device. These data are stored in a standard relational database in the database subsystem 32.

Each measurement device is typically given a category to indicate a genre. In one arrangement the categories include energy, home, health, environment, flora and fauna, transport, experiment and miscellaneous. These categories may be used for quickly evaluating the nature of each measurement device.

FIG. 3 is a flow diagram showing the operation of the server 12 in determining a score for a plurality of measurement devices. At step 40 in FIG. 3 the indexing subsystem 30 is configured to poll a measurement device for measurement data. The indexing subsystem 30 does this by accessing the data source URL for the relevant device, using a standard HTTP web client and the information stored in the database subsystem 32. Thus, the indexing subsystem 30 can retrieve actual real-time measurement data, if they are available. For each measurement device the indexing subsystem 30 is configured to record metrics to a database indicating whether it was able to retrieve data from the relevant URL, whether the retrieved data are up to date, and a snapshot of the data at the point of indexing. The indexing subsystem 30 is configured to poll each of the N measurement devices recorded in the database subsystem on a daily basis.

At step 42 the ranking subsystem 38 is configured to determine a score for each of the N measurement devices, based on the data retrieved by the indexing subsystem 30. The score determined at step 42 may be considered “intrinsic” since it is only influenced by the data retrieved by the indexing subsystem 30. In this embodiment the ranking subsystem 38 determines a positive score and a negative score for each device. FIG. 5 is a table showing a list of parameters that are used for calculating the positive and negative scores, and the relative weighting given to these parameters.

A positive score is established based on five parameters, as shown in FIG. 5:
1. the data source is available;
2. the data source is updating;
3. the completeness of the data source;
4. the congruency of the measurement data with data from similar devices in a local area; and
5. the number of measurement devices of the same specific type.

For the first parameter a positive score is calculated by examining whether the indexing subsystem 30 was successfully able to retrieve data from the relevant URL. The positive score for the first parameter is based on the number of consecutive days for which data have been retrieved successfully, and a weighting is applied.

For the second parameter a positive score is calculated by examining whether the measurement data have been recently updated. The positive score is based on the number of consecutive days for which data have been updated successfully, and a weighting is applied. Of course, in an alternative arrangement a different calculation method could be applied based on the number of consecutive seconds, minutes, hours, days or months for which data have been updated successfully.

For the third parameter a positive score is calculated by examining whether the measurement data from the measurement device are complete. In the example of the weather station 14 the measurement data would be considered complete if data are provided by all of the various components. In this embodiment a value is provided in the range 1-10, which is indicative of the completeness of the measurement data from each device.

For the fourth parameter a positive score is calculated based on the congruency of the measurement data with data from similar measurement devices in a local area. Again, in the context of the weather station 14, a high positive score is provided if the measurement data are consistent with data from other weather stations in a local area because this is an indication that the data are likely to be accurate. Conversely, a low score is provided if the data are not consistent because this may be indicative of a fault. In this embodiment a value is provided in the range 1-10, which is indicative of the congruency of the measurement data from each device.

For the fifth parameter a positive score is calculated based on the number of measurement devices of the same type. In this embodiment a value is provided in the range 1-10, which is indicative of the number of measurement devices of a specific type. A higher score is provided if there are many devices of the relevant type since this means that the measurement device is likely to be popular with users. A weighting is also provided for each device.

A negative score is established based on two parameters, as shown in FIG. 5:
1. the data source is not available; and
2. the data source is not updating.

For the first parameter a negative score is calculated by examining whether the indexing subsystem 30 was successfully able to retrieve data from the relevant URL. The negative score for the first parameter is based on the number of consecutive days for which data have not been retrieved successfully, and a weighting is applied.

For the second parameter a negative score is calculated by examining whether the measurement data have been recently updated. The negative score is based on the number of consecutive days for which data have not been updated successfully, and a weighting is applied.

A total positive score is obtained at step 42 by summing the positive scores for each of the five parameters listed above. A total negative score is also obtained. As discussed, these are intrinsic scores since they are based only on the data retrieved from the measurement devices by the indexing subsystem 30.

At step 44 in FIG. 3 the ranking subsystem 38 is configured to determine a score for each of the N measurement devices, based on user interaction with the measurement devices. The score determined at step 44 may be indicative of the popularity and/or credibility of the measurement devices among a community of users.

A positive score is established at step 44 based on five parameters, as shown in FIG. 6:
1. user endorses device;
2. user claims ownership of device;
3. user states that they have used the device;
4. user proves that they have used the device;
5. user comments on device
6. user interacts with device.

A negative score is established based on one parameter, as shown in FIG. 6. In particular, a negative score is established if users denounce the measurement device.

For each of the parameters above in step 44 the score is based on the number of relevant user interactions and a weighting factor is applied. For example the positive score for user endorsements is simply based on the number of endorsements received from users. In another example the positive score for user comments on device is based on the number of comments received from users.

The positive and negative scores determined in step 44 are calculated using a weighting factor that depends on the identity of the relevant users. In this embodiment there are four categories of user: anonymous, authenticated, verified and expert, and each category receives a different weighting.

The default position is that a user is anonymous. A user can qualify as authenticated by presenting some credentials. A user can qualify as verified by requesting verification and supplying their cell phone number, receiving a code and verifying their identity by entering the code to the presentation subsystem 36. The user can qualify as expert if they are nominated and accepted by a system administrator.

At step 46 the ranking subsystem 38 sums the positive scores from steps 42 and 44 and separately sums the negative scores from steps 42 and 44. The ranking subsystem 38 then calculates a quantity “n” which is the sum of the absolute values of the positive scores and the negative scores. The ranking subsystem 38 also calculates a quantity “P”, which is the absolute value of the positive scores, divided by “n”. Further, the ranking subsystem 38 calculates the lower bound of a Wilson score interval using the following expression:

$$( \hat{ρ} + \frac{{z}^{2}}{2 n} - z \sqrt{[ \hat{ρ} ( 1 - \hat{ρ} ) + {z}^{2} / 4 n ] / n} ) / ( 1 + {z}^{2} / n )$$

In this case “z” is the “1−a/2” percentile of a standard normal distribution.

The output of the calculation by the ranking subsystem 38 in step 46 is a real number in the range 0-1. This combined score represents the estimated relevance of the measurement device in the internet of things. The score reflects the accuracy, completeness and availability of real-time measurement data as well as user feedback on the measurement device. Thus, the combined score is reflective of the accuracy of the measurement device as well as its credibility and/or popularity with users. This technique has been found to be effective in determining a score that is actually reflective of the relevance of measurement devices in the internet of things, which is of great utility for search engines.

FIG. 4 is a flow diagram showing the operation of the server 12 in receiving a search string from a user and presenting search results. At step 50 in FIG. 4 the lexical retrieval subsystem 34 receives a search string from a user. At step 52 the user's search query is tokenized and normalized into unique lexemes; this process also removes common short words from the query such as “the”, “of”, “a” and “my”. For example, at step 52 the search string “My Energy Monitor” would be tokenized and normalized into “energi” and “monitor”. In another example, the search string “Waterlevel Monitoring” would be tokenized and normalized into “waterlevel” and “monitor”. In these examples “my” is removed and “energy” is converted into a normalized form; “monitor” and “monitoring” are normalized to the same value in this example.

At step 54 in FIG. 4 the lexemes from step 52 are matched with the titles, descriptions and metatags stored in the database subsystem 32 for each of the measurement devices. The matching process uses conventional lexical matching tools to return a score for each measurement device which is in the range of 0-1, where ‘0’ indicates no match and ‘1’ indicates a precise match.

At step 56 a final score is determined for each measurement device which returns a non-zero score at step 54. This is achieved by taking the numerical average between the score at step 54 and the combined score determined at step 46 for each measurement device, although a variety of alternative mathematical techniques may be used for combining these two scores. The final score determined at step 56 is an estimate for the relevance of each measurement device, given the search string submitted by the user.

At step 58 the presentation subsystem 36 determines the position of the user who submitted the search string. This may be achieved easily if the search request is submitted using a GPS-enabled device. Alternatively a position may be determined based on the Wi-Fi signal being used or the IP address of the computer used to submit the search request.

At step 60 the presentation subsystem 36 determines a geographic area over which results should be returned. In one arrangement the geographic area may be centred on the user's location determined at step 58 with a default radius. In another arrangement the geographic area may be based on geographic terms included in the user's search string. For example, if the user refers to a specific geographic location, such as “New York City” then this may be used to scale the geographic area over which results are determined. A larger scale may be provided if the user refers to a smaller geographic area such as “Manhattan” or “SoHo”.

At step 62 the presentation subsystem 36 displays a geographic map for the area determined at step 60. The geographic map is displayed on the display screen 4, 10 of the user device 2, 8. Markers are included on the geographic map at positions corresponding to measurement devices. The opacity of the markers is dependent on the score determined at step 56 so that a searching user can easily see which measurement devices are likely to be of most relevance. In the currently preferred embodiment higher opacity markers are provided for measurement devices with a greater estimated relevance. It has been found that this usefully guides users to the most relevant measurement devices, improving the ease with which users can navigate the internet of things.

Each marker is displayed with a colour that is indicative of the category of measurement device. As explained the categories of measurement device could include energy, home, health, environment, flora and fauna, transport, experiment and miscellaneous. By displaying the markers in this way it is possible to provide a further prompt in order to guide users to the most relevant measurement device.

Each marker on the map is selectable so that a user can reveal more information about the relevant measurement device. In the example of the weather station 14 the marker may be selected so that the user can acquire real-time data from each of the components. In the example of the door 18 the relevant marker could be selected so that the user can determine whether the door is currently open or closed; the user may also be able to access a data archive indicating the times at which the door was previously opened or closed.

In this example the geographic map is output at step 62 for display on the display screen 4, 10 of the user device 2, 8. As an alternative, or in addition, the search results and ranking scores for the plurality of measurement devices could be output in a machine readable format to provide access to machines on an automated basis through an application programming interface (API).

In one example of the present invention a user in London could submit a search string for measurement devices in the internet of things reading: “Waterlevel readings thames river London”. In this example the flow chart shown in FIG. 3 is run by the server 12 on a daily basis. The server is operable at step 42 to determine an intrinsic score for each measurement device based on the availability and quality of the data. Additionally, the server 12 is operable at step 44 to determine a score for each measurement device based on user interaction which is indicative of the popularity and/or credibility of the measurement devices among users. At step 46 the server 12 is operable to determine a combined score for every connected measurement device, including waterlevel monitors on the river Thames in London. When the user's search string is submitted the server 12 is operable at step 52 to tokenize and normalize the search terms and then at step 54 to match lexemes with titles, descriptions and metadata for measurement devices. In this specific example a high score would be determined at step 54 for measurement devices that determine waterlevel readings on the river Thames in London. At step 56 the server 12 is operable to determine a final score based on the score determined at step 54 and the score determined at step 46. Thus, a relatively high score would be determined for any waterlevel monitors on the river Thames.

At step 58 the server 12 is operable to determine the precise position of the user in London who submitted the search string. This allows the server to centralise a geographic map, based on the position of the user. At step 60 the server 12 can determine the display area so that it focuses on London because this geographic term is included in the user's search string. At step 62 the presentation subsystem 36 of the server 12 is operable to output a geographic map for display on the user's computer display screen 4 including markers associated with matching measurement devices. As discussed, the opacity of markers is dependent on the final score determined at step 56. In this example the geographic map would include a plurality of markers associated with waterlevel monitors on the river Thames. The most highly opaque markers are those that have been given a high score because they have high quality and highly available data, and because they have been given good user feedback by other users. The user's attention can therefore be focused on the markers that are likely to be most relevant to their search string, and the user can select any of the displayed markers in order to obtain more information about the relevant measurement device. Thus, the invention provides a powerful system and method for enabling a user to identify relevant measurement devices in the internet of things.

Many of the functional units described in this specification have been labeled as modules or subsystems in order to more particularly emphasize their implementation independence. For example, a subsystem may be implemented as a hardware circuit comprising custom VLSI circuits or gate arrays, off-the-shelf semiconductors such as logic chips, transistors, or other discrete components. A subsystem may also be implemented in programmable hardware devices such as field programmable gate arrays, programmable array logic, programmable logic devices or the like.

Subsystems or modules may also be implemented in software for execution by various types of processors. An identified subsystem of programmable or executable code may, for instance, comprise one or more physical or logical blocks of computer instructions which may, for instance, be organized as an object, procedure, or function. Nevertheless, the executables of an identified subsystem need not be physically located together, but may comprise disparate instructions stored in different locations which, when joined logically together, comprise the subsystem and achieve the stated purpose for the subsystem. Indeed, a subsystem and/or a program of executable code may be a single instruction, or many instructions, and may even be distributed over several different code segments, among different programs, and across several memory devices. Similarly, operational data may be identified and illustrated herein within subsystems, and may be embodied in any suitable form and organized within any suitable type of data structure. The operational data may be collected as a single data set, or may be distributed over different locations including over different storage devices, and may exist, at least partially, merely as electronic signals on a system or network.

The various system components and/or subsystems discussed herein may include one or more of the following: a host server, motherboard, network, chipset or other computing system including a processor for processing digital data; a memory device coupled to a processor for storing digital data; an input digitizer coupled to a processor for inputting digital data; an application program stored in a memory device and accessible by a processor for directing processing of digital data by the processor; a display device coupled to a processor and/or a memory device for displaying information derived from digital data processed by the processor; and a plurality of databases including memory device(s) and/or hardware/software driven logical data storage structure(s).

Various databases/memory devices described herein may include records associated with one or more functions, purposes, intended beneficiaries, benefits and the like of one or more subsystems as described herein or as one of ordinary skill in the art would recognize as appropriate and/or like data useful in the operation of the present invention.

As those skilled in the art will appreciate, any computers discussed herein may include an operating system, such as but not limited to: Android, iOS, BSD, IBM z/OS, Windows Phone, Windows CE, Palm OS, Windows Vista, NT, 95/98/2000, OS X, OS2; QNX, UNIX; GNU/Linux; Solaris; MacOS; and etc., as well as various conventional support software and drivers typically associated with computers. The computers may be in a home, industrial or business environment with access to a network. In an exemplary embodiment, access is through the Internet through a commercially-available web-browser software package, including but not limited to Internet Explorer, Google Chrome, Firefox, Opera, and Safari.

The present invention may be described herein in terms of functional block components, functions, options, screen shots, user interactions, optional selections, various processing steps, features, user interfaces, and the like. Each of such described herein may be one or more subsystems in exemplary embodiments of the invention even if not expressly named herein as being a subsystem. It should be appreciated that such functional blocks and etc. may be realized by any number of hardware and/or software components configured to perform the specified functions. For example, the present invention may employ various integrated circuit components, e.g., memory elements, processing elements, logic elements, scripts, look-up tables, and the like, which may carry out a variety of functions under the control of one or more microprocessors or other control devices. Similarly, the software elements of the present invention may be implemented with any programming or scripting language such as but not limited to Eiffel, Haskell, C, C++, Java, Python, COBOL, Ruby, assembler, Groovy, PERL, Ada, Visual Basic, SQL Stored Procedures, AJAX, Bean Shell, and extensible markup language (XML), with the various algorithms being implemented with any combination of data structures, objects, processes, routines or other programming elements. Further, it should be noted that the present invention may employ any number of conventional techniques for data transmission, signaling, data processing, network control, and the like. Still further, the invention may detect or prevent security issues with a client-side scripting language, such as JavaScript, VBScript or the like.

Additionally, many of the functional units and/or subsystems herein are described as being “in communication” with other functional units, third party devices/systems and/or subsystems. Being “in communication” refers to any manner and/or way in which functional units and/or subsystems, such as, but not limited to, computers, networks, mobile devices, program blocks, chips, scripts, drivers, instruction sets, databases and other types of hardware and/or software, may be in communication with each other. Some non-limiting examples include communicating, sending, and/or receiving data and metadata via: a wired network, a wireless network, shared access databases, circuitry, phone lines, internet backbones, transponders, network cards, busses, satellite signals, electric signals, electrical and magnetic fields and/or pulses, and/or so forth.

As used herein, the term “network” includes any electronic communications means which incorporates both hardware and software components of such. Communication among the parties in accordance with the present invention may be accomplished through any suitable communication channels, such as, for example, a telephone network, an extranet, an intranet, Internet, point of interaction device (point of sale device, personal digital assistant, cellular phone, kiosk, etc.), online communications, off-line communications, wireless communications, transponder communications, local area network (LAN), wide area network (WAN), networked or linked devices and/or the like. Moreover, although the invention may be implemented with TCP/IP communications protocols, the invention may also be implemented using other protocols, including but not limited to IPX, Appletalk, IP-6, NetBIOS, OSI or any number of existing or future protocols. If the network is in the nature of a public network, such as the Internet, it may be advantageous to presume the network to be insecure and open to eavesdroppers. Specific information related to the protocols, standards, and application software utilized in connection with the

Internet is generally known to those skilled in the art and, as such, need not be detailed herein.

1. A system configured to create a score for a plurality of measurement devices in a network, wherein the system comprises:
an indexing subsystem configured to retrieve a first set of data from the plurality of measurement devices in the network;
a user interaction subsystem configured to determine a second set of data regarding user interaction with the plurality of physical devices in the network;
a scoring module configured to determine a score for each of the plurality of devices based on the first set of data and the second set of data; and
a presentation subsystem configured to output an indication of the determined score for at least some of the plurality of measurement devices.

2. The system of claim 1 comprising a data storage unit configured to store properties for the plurality of measurement devices, wherein the presentation subsystem is configured to output at least one property for each measurement device together with the indication of the determined score.

3. The method of claim 2 wherein the properties include one more of the following: the location of the measurement device, an internet address for the measurement device, a title for the measurement device, a description for the measurement device, and an indication of the type of measurement data produced by the measurement device.

4. The system of claim 3 wherein the indexing subsystem is configured to retrieve the first set of data by accessing the internet address stored in the data storage unit for the relevant measurement device.

5. The system of claim 4 wherein the first set of data includes measurement data for the relevant measurement device.

6. The system of claim 5 wherein the scoring module is configured to determine a score for a measurement device based on the availability of measurement data and/or the frequency with which the measurement data are updated.

7. The system of claim 5 wherein the scoring module is configured to determine a score for a measurement device based on the congruency of its measurement data with other devices in the network.

8. The system of claim 5 wherein the scoring module is configured to determine a score for a measurement device based on the completeness of its measurement data.

9. The system of claim 1 wherein the second set of data includes information indicative of the popularity and/or credibility of measurement devices among users.

10. The system of claim 1 wherein the second set of data includes one or more of the following: user endorsements of devices, user denouncements of devices, user comments on devices, information regarding the access of data from measurement devices, and user ownership of devices.

11. The system of claim 9 wherein the second set of data includes information indicative of the popularity and/or credibility of measurement devices in a plurality of categories of users, and wherein the score is determined differently according to popularity and/or credibility in the different categories.

12. The system of claim 3 further comprising a word search subsystem configured to receive a search string from a user and return results for matches in the title and/or description of measurement devices.

13. The system of claim 12 wherein the presentation subsystem is configured to output a geographic map including a plurality of markers associated with the positions of matching results, wherein at least one aspect of the appearance of each marker is dependent on the score determined by the scoring module.

14. The system of claim 13 wherein the prominence of the marker is dependent on the score.

15. The system of claim 14 wherein the prominence of the marker is related to its opacity.

16. The system of claim 13 wherein another aspect of the appearance of each marker is dependent on the type of the measurement device.

17. The system of claim 13 wherein the presentation subsystem is configured to determine a position for the user from whom the search string is received, and wherein the positions of the plurality of markers are within a predetermined distance of the determined position for the user.

18. The system of claim 13 wherein the scale of the geographic map is determined based on a geographical term in the search string.

19. The system of claim 1 comprising a display screen configured to display the indication of the determined score for at least some of the plurality of measurement devices.

20. A system configured to return the results of a search query for measurement devices in a network, wherein the system comprises:
a word search subsystem configured to receive a search string from a user and search for matching results in the titles and/or descriptions of measurement devices, wherein the word search subsystem determines a score for each measurement device which is indicative of the closeness of match; and
a presentation subsystem configured to output a geographic map including a plurality of markers associated with the positions of matching results, wherein at least one aspect of the appearance of each marker is dependent on the score.

21. The system of claim 20 further comprising:
an indexing subsystem configured to retrieve a first set of data from the plurality of measurement devices in the network;
a user interaction subsystem configured to determine a second set of data regarding user interaction with the plurality of physical devices in the network; and
a scoring module configured to determine a score for each of the plurality of devices based on the first set of data and the second set of data, wherein the appearance of each marker dependent on the score determined by the scoring module as well as the score determined by the word search subsystem.

22. A method of creating a score for a plurality of measurement devices in a network, the method comprising the steps of:
retrieving a first set of data from the plurality of measurement devices in the network;
determining a second set of data regarding user interaction with the plurality of physical devices in the network;
determining a score for each of the plurality of devices based on the first set of data and the second set of data; and
outputting an indication of the determined score for at least some of the plurality of measurement devices.

23. A non-transitory computer readable storage medium having a computer program stored thereon, the computer program comprising processor readable instructions that, when executed, direct a device to perform actions comprising:
retrieving a first set of data from the plurality of measurement devices in the network;
determining a second set of data regarding user interaction with the plurality of physical devices in the network;
determining a score for each of the plurality of devices based on the first set of data and the second set of data; and
outputting an indication of the determined score for at least some of the plurality of measurement devices.
